(19) United States
(12) Patent Application Publication
(10) Pub. No.: US 2010/0201199 A1
(43) Pub. Date: Aug. 12, 2010

(54) Power conversion device

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,002

(22) Filed: Feb. 11, 2009

(51) Int. Cl. H02M 1/10

(52) U.S. Cl. 307/80

(57) ABSTRACT

A power conversion device includes a combination of at least one power supply, a power converter, an inverter, a converter, an AC power circuit, a power output selection device, and a control unit. The at least one power supply is converted by the inverter and the converter to provide an output of AC power or DC power connected to the power output selection device and the control unit is used to effect control of the distribution of input power supplies in the conversion of power and to ensure power output of the power output selection device so that the present invention allows for timed management and distribution of power flows for the AC power outputs from the electric main and the inverter in order to provide stable AC power output and provide DC power outputs of different voltage levels for powering various electric appliances.

### FIELD OF THE INVENTION

The present invention relates to a power conversion device, and in particular to such as device that comprises a combination of at least one power supply, a power converter, an inserter, a converter, an alternate-current (AC) power circuit, a power output selection device, and a control unit, wherein the control unit effects control over the sequence of input/output powers and arrangement of AC power supply ratio between an electric main and the inverter and employs a signal from a program controller to realize the arrangement and is thus applicable to all sorts of power conversions and the likes.

### BACKGROUND OF THE INVENTION

Electrical power supplied through an electric main is commonly alternate current (AC). However, with the change of energy consumer's philosophy, replacement energies are proposed recently, including fuel-burning power generation, wind power generation, solar energy power generation, and even fuel cells. They are all capable to provide a desired power supply to ordinary uses and operations. Thus, it is apparently insufficiency by only using the electric main as a sole power supply. However, those substitute power supplies currently available in the market suffer their own drawbacks in economically and effectively replacing the electric main. For example, their performance may be affected by whether the weather is sunny or cloudy or by the variation of direction and magnitude of wind. Further, such substitute power supplies only provide limited power that must be sufficiently accumulated in for example a battery or accumulator before the power can be used. And, in using such substitute powers, a user must perform certain switching operation by himself or herself, in order to switch among different power supplies.

Further, a regular electrical appliance is designed to receive AC power input and is generally not adapted to the above mentioned substitute power supplies that are often unstable and insufficient. Thus, management of various power supplies in using multiple power supplies as a combined input represents a significant problem for overloading often occurs and risk caused by power overloading, such as device malfunctioning and fires, may leads to severe operation safety problem. Thus, the present invention aims to provide a power conversion device that realizes smooth and effective conversion of power among various power supplies to thereby eliminate the above discussed problems.

### SUMMARY OF THE INVENTION

An objective of the present invention is to provide a power conversion device that comprises s a combination of at least one power supply, a power converter, an inverter, a converter, an AC power circuit, a power output selection device, and a control unit, wherein the power converter converts a power provided from the at least one power supply into a DC power input; the inverter and the converter convert the DC power from the power converter into an AC power output and a different DC power output respectively; the AC power circuit comprises a switching device for controlling the transmission of AC power output; and the control unit sets a sequence of power outputs, arranges AC power output ratio between the AC powers from the electric main and the inverter, and uses a program controller to control and manage all the power inputs/outputs, whereby the present invention allows for timed management and distribution of power flows for the AC power outputs from the electric main and the inverter in order to provide stable power output and provide DC power outputs of different voltage levels for various electric appliances and thus enhancing overall practicability and convenience.

Another objective of the present invention is to provide a power conversion device that comprises a combination of at least one power supply, a power converter, an inverter, a converter, an AC power circuit, a power output selection device, and a control unit, wherein the power converter converts a power provided from the at least one power supply into a DC power input; the inverter and the converter convert the DC power from the power converter into an AC power output and a different DC power output respectively; the AC power circuit comprises a switching device for controlling the transmission of AC power output; and the control unit controls the sequence of power outputs, arranges AC power output ratio between the AC powers from the electric main and the inverter, provides DC power outputs of various voltage levels, and uses a program controller to control and manage all the power inputs/outputs in order to realize balance of power output, which is free of overloading, for the power output selection device so that the present invention features self-protection to ensure operation safety for the users thereby enhancing overall practicability.

To realize the above objectives, in accordance with the present invention, a power conversion device comprises a combination of at least one power supply, a power converter, an inverter, a converter, an AC power circuit, a power output selection device, and a control unit, wherein the power converter converts a power provided from the at least one power supply into a DC power input; the inverter and the converter convert the DC power from the power converter into an AC power output and a different DC power output respectively; the AC power circuit comprises a switching device for controlling the transmission of AC power output, where the AC power circuit has a terminal connected to an electric main and another terminal connected to the inverter; the power output selection device receives the DC power output from the converter and also receives the AC power output from the AC power circuit and is connected to at least one electric appliance; and the control unit employs a signal to control the power converter for setting the distribution of input powers in the conversion of power and uses a signal to control the power output selection device for controlling power supplied to the at least one electric appliance, whereby the at least one power supply is converted by the inverter and the converter to provide an output of AC power or DC power connected to the power output selection device and the control unit is used to effect control of the distribution of input power supplies in the conversion of power and to ensure power output of the power output selection device so that the present invention allows for timed management and distribution of power flows for the AC power outputs from the electric main and the inverter in order to provide stable AC power output and provide DC power outputs of different voltage levels for powering various electric appliances and thus enhancing overall practicability and convenience.

### BRIEF DESCRIPTION OF THE DRAWINGS

The present invention will be apparent to those skilled in the art by reading the following description of a preferred embodiment thereof with reference to the drawings, in which:

FIG. 1 is a schematic block diagram of a power conversion device constructed in accordance with the present invention; and

FIG. 2 is a detailed block diagram of the power conversion device in accordance with the present invention.

### DETAILED DESCRIPTION OF THE PREFERRED EMBODIMENT

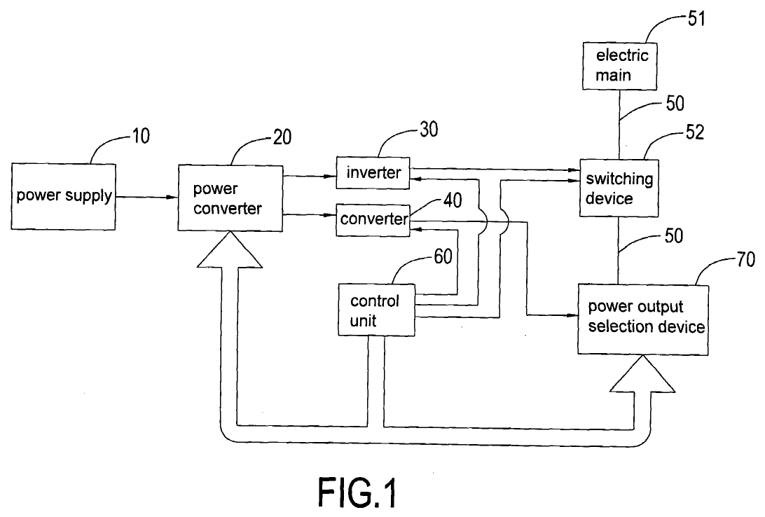

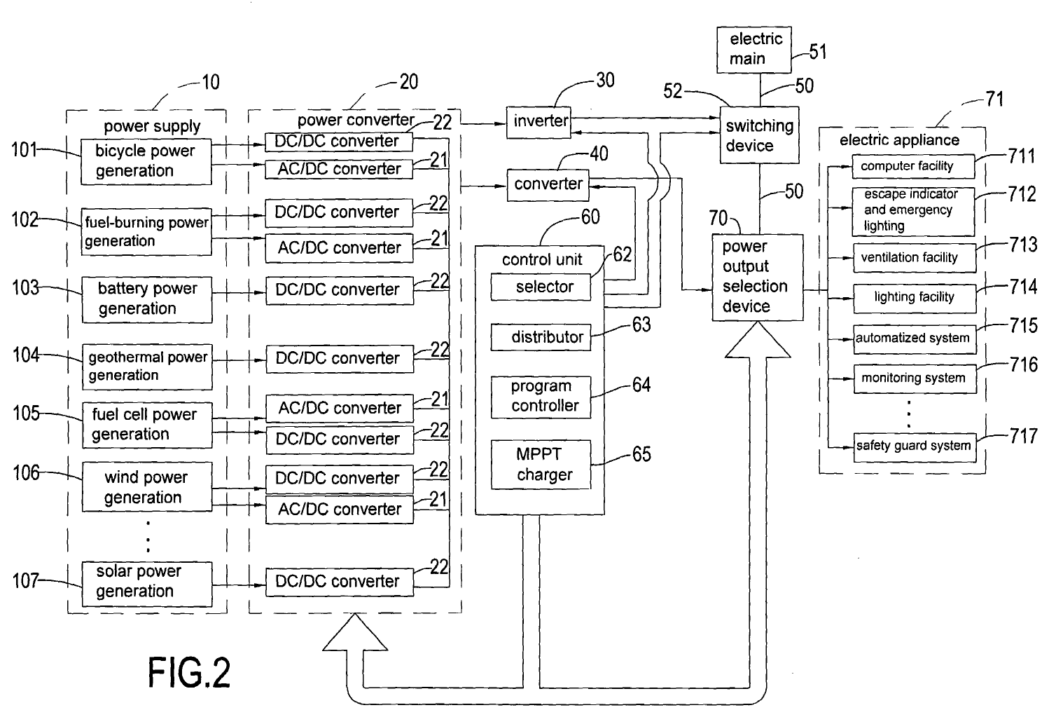

With reference to the drawings and in particular to FIGS. 1 and 2, the present invention provides a power conversion device, comprising at least one power supply 10 and a power converter 20 that is connected to the at least one power supply 10. The power converter 20 comprises an AC (alternate current)/DC (direct current) converter 21 and a DC/DC converter 22, associated with each power supply 10, for conversion of an electrical power received from the power supply 10 into a DC power input.

An inverter 30 has a terminal connected to the power converter 20 for inverting the DC power input that is supplied from the power converter 20 into an AC power output.

A converter 40 is connected to the power converter 20 for converting the DC power input that is supplied from the power converter 20 into a different DC power output, which may be of a different voltage level.

An AC power circuit 50 comprises a switching device 52 for controlling transmission of the AC power output. The AC power circuit 50 has a terminal connected to an electric main 51 and another terminal connected to the output of the inverter 30.

A power output selection device 70 receives the DC power output from the converter 40, and the DC power output from the converter 40, as mentioned above, is one that is different from the DC power input supplied from the power converter 20. The power output selection device 70 also receives the AC power supplied through the switching device 52 of the AC power circuit 50. The power output selection device 70 is electrically connectable to at least one electric appliance 71 for supplying power thereto.

A control unit 60 is connected to the switching device 52 of the AC power circuit 50 and the inverter 30. The control unit 60 is connected to the converter 40. The control unit 60 supplies a signal to control the power converter 20 in order to control distribution of inputs from the power supplies. The control unit 60 uses a signal to control the power output selection device 70 in order to supply power to the at least one electrical appliance in a desired manner.

In the embodiment illustrated, the at least one power supply 10 comprises one or more power supplies selected among bicycle power generation 101, fuel-burning power generation 102, battery power generation 103, geothermal power generation 104, fuel cell power generation 105, wind power generation 106, and solar power generation 107. The power converter 20 is connected to those power supplies 10 (at least one power supply 10 being sufficient for a practical operation). The power converter 20 comprises an AC/DC converter 21 and a DC/DC converter 22 corresponding to each of the at least one power supply 10 for performing conversion of different power supply 10, such as bicycle power generation 101, fuel-burning power generation 102, fuel cell power generation 105, or wind power generation 106 that generates either DC power or AC power supplied to the device, into a DC power that will serve as an input to the device. AC power from such various power supplies is converted by the AC/DC converter 21 of the power converter 20 into a DC power; DC power from such various power supplies is converted by the DC/DC converter 22 of the power converter 20 into another DC power for applying to the device. Other power supplies, such as battery power generation 103 and solar power generation 107, can be arranged to be associated with the DC/DC converter 22 of the power converter 20 for being converted thereby into another DC power.

The inverter 30 changes the DC power supplied from the power converter 20 into an AC power. The converter 40 converts the DC power from the power converter 20 into a different DC power. Additionally, an AC power circuit 50 is provided, wherein the AC power circuit 50 comprises a switching device 52 arranged thereon. The switching device 52 of the AC power circuit 50 comprises a three-way switch, which controls the AC power output from the electric main 51 and also controls the AC power output from the inverter 30. The DC power output from the converter 40 and the AC power output from the three-way switch are both supplied to the power output selection device 70, which is in turn connected to various electric appliances 71. In the embodiment illustrated, the electric appliances 71 may include computer facility 711, escape indicator and emergency lighting 712, ventilation facility 713, lighting facility 714, automatized systems 715, monitoring systems 716, safety and guard systems 717, and the likes. (In a practical application, a sole electric appliance 71 is sufficient for the operation of the present invention.) The power output selection device 70 functions to supply proper DC or AC power to the various electric appliances 71.

With the connection with the switching device 52 of the AC power circuit 50 and the inverter 30, the control unit 60 is capable to control the output of AC power and with the connection with the converter 40, the control unit 60 is also capable to control and distribute DC power output that is obtained from various DC inputs. The control unit 60 comprises a selector 62, a distributor 63, a program controller 64, and a MPPT (Maximum Power Point Tracking) charger 65. The selector 62 allows the control unit 60 to select a sequence for power output. The distributor 63 functions to arrange or set AC power output ratio between the AC powers from the electric main 51 and the inverter 30. The program controller 64 contains a program or programs to control and manage the power inputs to the power converter 20. The MPPT charger 65 tracks the condition of power supplying to the power converter 20. The control unit 60 employs a signal to control the power converter 20 for controlling distribution among inputs from the various power supplies in performing power conversion. The control unit 60 uses a signal to control the power output selection device 70 for controlling the AC power output and various DC power outputs supplied to the electric appliances 71 (which can be only one in a practical application).

The inverter 30 has a terminal connected to the power converter 20 and the inverter 30 inverts a DC power output from the power converter 20 into an AC power. The AC power output of the inverter 30 is connected to the AC power circuit 50 to provide an AC power output of the device. The converter 40 is also connected to the power converter 20 to convert a DC power output from the power converter 20 into a DC power output of different voltage level. When a user wishes to use DC power, the converter 40 converts the output DC power from the power converter 20 into an output of DC power that has a voltage level as desired by the user and is transmitted to the power output selection device 70. The power output selection device 70 in turn distributes the DC power outputs of various voltage levels in accordance with the various electric appliances 71, or controls the time period of power output. When the user wishes to use AC power, the control unit 60 controls the switching operation of the switching device 52 of the AC power circuit 50 in order to supply an output of AC power. The control unit 60 also functions to control the distribution among the inputs of power supplies during the conversion of power. When the inverter 30 provides an insufficient output of AC power, the control unit 60 controls the switching device 52 of the AC power circuit 50 to allow the electric main 51 to supplement the AC power output of the circuit so as to ensure the AC power output supplied from the power output selection device 70. The control unit 60 comprises the distributor 63 that functions to set the distribution of power output ratio, whereby the distributor 63, based on the desire of the user, controls and sets different ratios between the power outputs of the inverter 30 and the electric main 51, such as the inverter 30 providing an output that takes 60% of the total AC power output of the AC power circuit 50, in combination with the electric main 51 supplying 40% of the total AC power output, which together provide 100% of the desired power output. The program controller 64 of the control unit 60 can, based on preset programming, control and manage a distribution ratio of input power supplies 10. For example, in sunny daytime, the solar energy power generation 107 provides ample input power; in a windy weather, the wind power generation 106 serves as a major input. The program controller 64 can control and manage the power supplies that are applied to the 20 according to the desires of the user. The MPPT charger 65 of the control unit 60 may track and identify the ones of the power supplies 10 that are in good condition for supplying power to the power converter 20.

Referring to FIGS. 1 and 2, the power conversion device of the present invention features a combination of at least one power supply 10, a power converter 20, an inverter 30, a converter 40, an AC power circuit 50, power output selection device 70, and a control unit 60, wherein the power converter 20 comprises an AC/DC converter 21 and a DC/DC converter 22, corresponding to each power supply 10, for converting power provided from the power supply 10 into a DC power input for the power conversion device; the inverter 30 and the converter 40 are connected to the power converter 20 for converting the DC power from the power converter 20 into an AC power output and a different DC power output respectively; the AC power circuit 50 comprises a switching device 52 for controlling the transmission of AC power output, where the AC power circuit 50 has a terminal connected to an electric main 51 and another terminal connected to the output of the inverter 30; the power output selection device 70 receives said different DC power output from the converter 40 and also receives the AC power output from the switching device 52 of the AC power circuit 50, and is further connected to at least one electric appliance 71; the control unit 60 comprises a selector 62, a distributor 63, a program controller 64, and a MPPT charger 65, where the control unit 60 sets a sequence of power inputs/outputs, arranges AC power output ratio between the AC powers from the electric main 51 and the inverter 30, and uses the program controller 64 to control and manage the power inputs to the power converter 20; the MPPT charger 65 tracks the ones of the power supplies 10 that are in good condition for supplying power to the power converter 20; and the control unit 60 employs a signal to control the power converter 20 to control the distribution among input power supplies in performing power conversion and also uses a signal to control the power output selection device 70 for controlling power supplied to the at least one electric appliance 71, whereby the present invention allows for timed management and distribution of power flows for the AC power outputs from the electric main 51 and the inverter 30 in order to provide DC power outputs of different voltage levels and supply the electric power to at least one electric appliance 71 through the power output selection device 70 to thereby ensure operation safety for the users and thus enhancing overall practicability and convenience.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A power conversion device, comprising:
at least one power supply;
a power converter, which is connected to the at least one power supply and comprises an AC/DC converter and a DC/DC converter for conversion of an electrical power received from the at least one power supply into a DC power input;
an inverter, which has a terminal connected to the power converter for inverting the DC power input that is supplied from the power converter into an AC power output;
a converter, which is connected to the power converter for converting the DC power input that is supplied from the power converter into a different DC power output;
an AC power circuit, which comprises a switching device for controlling transmission of AC power output, the AC power circuit having a terminal connected to an electric main and another terminal connected to the output of the inverter;
a power output selection device, which receives the different DC power output from the converter, the power output selection device receiving the AC power output from the switching device of the AC power circuit, the power output selection device being connected to at least one electric appliance; and
a control unit, which is connected to the switching device of the AC power circuit and the inverter, the control unit being connected to the converter, the control unit supplying a signal to control the power converter in order to control distribution of power supply in performing power conversion, the control unit issuing a signal to control the power output selection device to control power supplied to the at least one electric appliance.

2. The power conversion device as claimed in claim 1, wherein the at least one power supply comprises a power supply selected among bicycle power generation, fuel power generation, battery power generation, geothermal power generation, fuel cell power generation, wind power generation, and solar power generation.

3. The power conversion device as claimed in claim 1, wherein the switching device of the AC power circuit comprises a three-way switch.

4. The power conversion device as claimed in claim 1, wherein the control unit comprises a selector for selecting a sequence for power output.

5. The power conversion device as claimed in claim 1, wherein the control unit comprises a distributor for distributing ratio of power output.

6. The power conversion device as claimed in claim 1, wherein the control unit comprises a program controller for program-controlling and managing power input.

7. The power conversion device as claimed in claim 1, wherein the control unit comprises a MPPT (Maximum Power Point Tracking) charger for tracking status of power supplying to the power converter.

8. The power conversion device as claimed in claim 1, wherein the electric appliance selectively comprises one of computer facility, escape indicator and emergency lighting, ventilation facility, lighting facility, automatized systems, monitoring systems, and safety guard systems.
